(19) United States
(12) Patent Application Publication
(10) Pub. No.: US 2024/0024911 A1
(43) Pub. Date: Jan. 25, 2024

(54) Die Coater Shim and Die Coater for Coating Active Material on Current Collector for Secondary Battery

(71) Applicant: LG Energy Solution, Ltd, Seoul (KR)

(72) Inventors: Joon Sun Park, Daejeon (KR); Man Hyeong Kim, Daejeon (KR); Min Hyuck Choi, Daejeon (KR); Guk Tae Kim, Daejeon (KR)

(73) Assignee: LG Energy Solution, Ltd, Seoul (KR)

(21) Appl. No.: 18/266,330

(22) PCT Filed: Oct. 31, 2022
(86) PCT No.: PCT/KR2022/016788

§ 371 Date: Jun. 9, 2023

(30) Foreign Application Priority Data
Nov. 29, 2021 (KR) 10-2021-0167134

(51) Int. Cl. B05C 5/02; H01M 4/04

(52) U.S. Cl. CPC B05C 5/0254; H01M 4/0404

(57) ABSTRACT

A die coater shim and die coater for simultaneously coating an electrode slurry and an insulating coating liquid. The die coater shim includes: a base that extends in a width direction; first and second guides that protrude and extend from both ends of the base; an electrode slurry slit that includes a step portion that extends from the base in the width direction between the first and second guides, wherein a thickness of the step portion is smaller than a thickness of the base, and a stepped space that the step portion forms relative to one surface of the base to form an electrode slurry discharge path; and first and second insulating coating liquid slits which include a groove on a surface of each of the first and second guides, wherein one end of the groove forms an insulating coating liquid discharge path.

### CROSS-REFERENCE TO RELATED APPLICATIONS

The present application is a national phase entry under 35 U.S.C § 371 of International Application No. PCT/KR2022/016788 filed on Oct. 31, 2022, which claims the benefit of priority based on Korean Patent Application No. 10-2021-0167134, filed on Nov. 29, 2021, all contents of which are incorporated herein by reference.

### TECHNICAL FIELD

The present invention relates to a die coater shim and die coater for effectively and simultaneously coating an electrode slurry and an insulating coating liquid on a current collector for a secondary battery.

### BACKGROUND ART

With the development of technology and an increase in demand for mobile devices, the demand for secondary batteries is also rapidly increasing. Among secondary batteries, lithium secondary batteries are widely used as an energy source of various electronic products as well as various mobile devices due to having high energy density and high operating voltage and being excellent in terms of preservation and lifespan.

An electrode in which an active material layer and an insulating layer are formed on a surface of a current collector is used in a lithium secondary battery or the like. Such an electrode is manufactured by applying both an electrode slurry including an active material or the like and an insulating coating liquid including an insulating material or the like on a surface of a current collector using a coating apparatus such as a die coater so that the electrode slurry and the insulating coating liquid overlap with a portion of a corner of an electrode mixture layer and drying the electrode slurry and the insulating coating liquid.

FIG. 1 illustrates a conventional die coater 1 for applying an electrode slurry. The die coater 1 includes an upper block 2 and a lower block 3, a die coater shim 4 is interposed between the upper block 2 and the lower block 3, and the upper block 2, the lower block 3, and the die coater shim 4 are fastened using a plurality of bolt members and coupled to each other. A manifold 5 configured to accommodate a certain volume of electrode slurry is provided in the lower block 3, and the manifold 5 communicates with an external electrode slurry supply (not illustrated).

Here, the die coater shim simultaneously serves to form a slit of a suitable height between the upper block and the lower block, limit a flowing direction of an electrode slurry so that the electrode slurry is discharged toward the slit, and perform sealing so that the electrode slurry does not leak to portions other than the slit. The die coater shim has guides protruding from both ends thereof in a width direction, and a distance between the guides determines a width at which the electrode slurry is applied on a current collector.

An insulating coating liquid is applied on both corners in the width direction of the electrode slurry applied on the current collector. Generally, applying the insulating coating liquid is performed as an additional process using a separate apparatus after applying the electrode slurry on the current collector. Applying the electrode slurry and the insulating coating liquid on the current collector through separate processes in this way is undesirable in terms of production efficiency.

In order to address such a problem, a technology that forms independent slits, each discharging an electrode slurry and an insulating coating liquid, in a single die coater shim has been introduced, but there is a problem that, in a case in which any one solution leaks in the die coater, the two solutions (the electrode slurry and the insulating coating liquid) are mixed, or the two solutions are mixed and discharged from an outlet of the slit, which may cause poor quality of a current collector.

### DISCLOSURE

### Technical Problem

An object of the present invention is to provide a die coater shim and die coater for simultaneously and effectively coating an electrode slurry and an insulating coating liquid on a current collector for a secondary battery.

### Technical Solution

A die coater shim and die coater for simultaneously and effectively coating an electrode slurry and an insulating coating liquid are provided. In one embodiment, a die coater shim according to the present invention includes: a base configured to extend in a width direction; first and second guides configured to protrude and extend from both ends of the base; an electrode slurry slit including a step portion configured to extend from the base in the width direction between the first and second guides, wherein a thickness of the step portion is smaller than a thickness of the base, and a stepped space that the step portion forms relative to one surface of the base forms an electrode slurry discharge path; and first and second insulating coating liquid slits including a groove formed on a surface of each of the first and second guides that corresponds to the other surface of the base, wherein one end of the groove forms an insulating coating liquid discharge path.

In a specific embodiment, the step portion may extend to a partial area in the width direction between the first and second guides.

Also, the one end of the groove that forms an outlet of the first and second insulating coating liquid slits may extend to protruding end portions of the first and second guides.

In a specific embodiment, the one end of the groove may be spaced apart from inner corners of the first and second guides that face each other.

In another embodiment, the die coater shim may further include a third guide positioned between the first and second guides and configured to protrude and extend from the base, the step portion may be formed of a first step portion disposed between the first and third guides and a second step portion disposed between the third and second guides, the electrode slurry slit may be formed of a first electrode slurry slit configured to form a first electrode slurry discharge path using the first step portion and a second electrode slurry slit configured to form a second electrode slurry discharge path using the second step portion, and the die coater shim may further include third and fourth insulating coating liquid slits including a pair of grooves formed on a surface of the third guide that corresponds to the other surface of the base, wherein one end of each of the pair of grooves forms an insulating coating liquid discharge path.

In a specific embodiment, outlets of the third and fourth insulating coating liquid slits may face the first and second guides.

Further, widths of the first and second step portions may be equal to each other.

Meanwhile, an aspect of the present invention provides a die coater including: an upper block in which an insulating coating liquid inlet is provided; a lower block coupled to the upper block and in which a manifold configured to accommodate an electrode slurry is provided; and a die coater shim interposed between the upper block and the lower block to form a slit and configured to simultaneously discharge an insulating coating liquid and the electrode slurry through the slit, wherein the die coater shim has an electrode slurry discharge path formed on one surface and an insulating coating liquid discharge path formed on the other surface opposite to the one surface, and the electrode slurry discharge path and the insulating coating liquid discharge path are physically separated from each other on the die coater shim.

In one embodiment, the die coater shim may include: a base configured to extend in a width direction; first and second guides configured to protrude and extend from both ends of the base; an electrode slurry slit including a step portion configured to extend from the base in the width direction between the first and second guides, wherein a thickness of the step portion is smaller than a thickness of the base, and a stepped space that the step portion forms relative to one surface of the base forms an electrode slurry discharge path; and first and second insulating coating liquid slits including a groove formed on a surface of each of the first and second guides that corresponds to the other surface of the base, wherein one end of the groove forms an insulating coating liquid discharge path.

Further, the step portion may extend to a partial area in the width direction between the first and second guides.

In a specific embodiment, a boundary between the base and the step portion may coincide with a rear end of the manifold provided in the lower block, and an end portion of the step portion may coincide with a front end of the manifold or protrude from the front end of the manifold.

For example, the end portion of the step portion may protrude 10 mm or less from the front end of the manifold.

In another embodiment, the one end of the groove that forms an outlet of the first and second insulating coating liquid slits may extend to protruding end portions of the first and second guides.

In a specific embodiment, the one end of the groove may be spaced apart from inner corners of the first and second guides that face each other.

### Advantageous Effects

A die coater shim of the present invention is configured to simultaneously discharge an insulating coating liquid and an electrode slurry, and in particular, an electrode slurry discharge path and an insulating coating liquid discharge path are physically separated from each other on the die coater shim.

Accordingly, the die coater shim of the present invention effectively prevents the electrode slurry and the insulating coating liquid from being mixed with each other even when the electrode slurry and/or the insulating coating liquid leak inside a die coater.

Therefore, the present invention allows an electrode slurry and an insulating coating liquid to be simultaneously and effectively coated on a current collector for a secondary battery.

Advantageous effects of the present invention are not limited to those mentioned above, and other unmentioned advantageous effects should be clearly understood by those of ordinary skill in the art from the detailed description below.

### BRIEF DESCRIPTION OF THE DRAWINGS

FIG. 1 is a view illustrating a configuration of a die coater according to the related art.

FIG. 2 is a view illustrating a structure of a die coater including a die coater shim according to an embodiment of the present invention.

FIG. 3 shows cross-sectional views taken along lines “A-A” and “B-B” of FIG. 2 in a state in which the die coater of FIG. 2 is assembled.

FIG. 4 is a front view of the die coater of FIG. 2 in the state in which the die coater is assembled.

FIG. 5 is a view illustrating a specific structure of the die coater shim illustrated in FIG. 2.

FIG. 6 is a view schematically illustrating a state in which an electrode slurry and an insulating coating liquid are simultaneously applied using the die coater of FIG. 2.

FIG. 7 is a view illustrating a die coater shim according to another embodiment of the present invention.

### DETAILED DESCRIPTION

Since various modifications may be made to the present invention and the present invention may have various embodiments, specific embodiments will be described in detail below.

However, this does not limit the present invention to the specific embodiments, and all modifications, equivalents, or substitutes included in the spirit and technical scope of the present invention should be understood as belonging to the present invention.

In the present disclosure, terms such as “include” or “have” should be understood as specifying that features, numbers, steps, operations, elements, components, or combinations thereof are present and not as precluding the possibility of the presence or addition of one or more other features, numbers, steps, operations, elements, components, or combinations thereof in advance.

Also, in the present disclosure, when a part such as a layer, a film, an area, or a plate is described as being “on” another part, this includes not only a case where the part is “directly on” the other part, but also a case where still another part is present therebetween. On the contrary, when a part such as a layer, a film, an area, or a plate is described as being “under” another part, this includes not only a case where the part is “directly under” the other part, but also a case where still another part is present therebetween. Also, in the present application, being disposed “on” may include not only being disposed on an upper portion, but also being disposed on a lower portion.

The present Invention provides a die coater shim and die coater for simultaneously and effectively coating an electrode slurry and an insulating coating liquid.

In one embodiment, a die coater shim according to the present invention includes: a base configured to extend in a width direction; first and second guides configured to protrude and extend from both ends of the base; an electrode slurry slit including a step portion configured to extend from the base in the width direction between the first and second guides, wherein a thickness of the step portion is smaller than a thickness of the base, and a stepped space that the step portion forms relative to one surface of the base forms an electrode slurry discharge path; and first and second insulating coating liquid slits including a groove formed on a surface of each of the first and second guides that corresponds to the other surface of the base, wherein one end of the groove forms an insulating coating liquid discharge path.

In particular, since the die coater shim according to the present invention has the electrode slurry discharge path formed on one surface and the insulating coating liquid discharge path formed on the other surface opposite to the one surface, the die coater shim can simultaneously apply an electrode slurry and an insulating coating liquid on a current collector. Further, since the electrode slurry discharge path and the insulating coating liquid discharge path are physically separated from each other on the die coater shim, even when any one solution leaks in a die coater, the two solutions are prevented from being mixed with each other.

### MODES OF THE INVENTION

Hereinafter, a die coater shim and die coater for simultaneously and effectively coating an electrode slurry and an insulating coating liquid on a current collector for a secondary battery according to embodiments of the present invention will be described in detail with reference to the accompanying drawings.

### First Embodiment

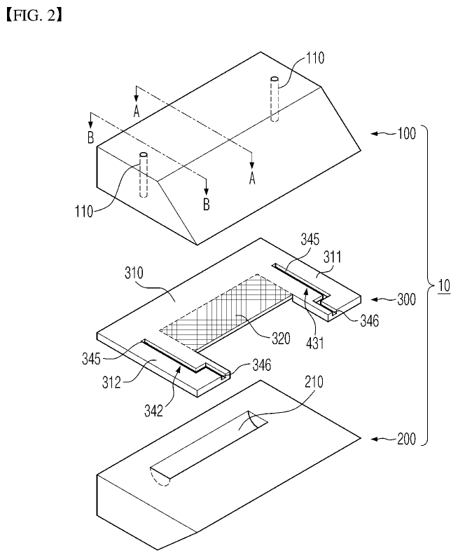

FIG. 2 is a view illustrating a structure of a die coater 10 including a die coater shim 300 according to an embodiment of the present invention. The overall configuration of the die coater 10 and the die coater shim 300 will be described in detail below with reference to FIG. 2.

The die coater 10 includes an upper block 100 and a lower block 200, and the die coater shim 300 is interposed between the upper block 100 and the lower block 200.

The upper block 100 and the lower block 200 are parts constituting a body of the die coater 10, an insulating coating liquid inlet 110 is provided in the upper block 100, and a manifold 210 configured to accommodate an electrode slurry supplied from an outside is provided in the lower block 200.

The die coater shim 300 is interposed between the upper block 100 and the lower block 200 to form a slit having a height suitable for discharging the electrode slurry. Also, the die coater shim 300 serves to limit a flowing direction of the electrode slurry so that the electrode slurry is discharged toward the slit without flowing backward and serves to perform sealing so that the electrode slurry does not leak to portions other than the slit.

As illustrated in FIG. 2, the die coater shim 300 has guides 311 and 312 protruding from both ends thereof in a width direction, and a distance between the guides 311 and 312 determines a width at which the electrode slurry is applied on a current collector.

The die coater shim 300 of the present embodiment is the same as the related art in that a slit for discharging an electrode slurry is formed therein but is different from the related art in that the die coater shim 300 of the present embodiment is configured to simultaneously discharge an insulating coating liquid and an electrode slurry.

In particular, the die coater shim 300 of the present embodiment has an electrode slurry discharge path formed on the bottom surface of the base and an insulating coating liquid discharge path formed on the top surface of the base, and the electrode slurry discharge path and the insulating coating liquid discharge path are physically separated from each other on the die coater shim 300. Since the electrode slurry discharge path and the insulating coating liquid discharge path are physically separated in this way, even when any one liquid (the electrode slurry and/or the insulating coating liquid) leaks inside the die coater 10, the one liquid is effectively prevented from being mixed with the other liquid.

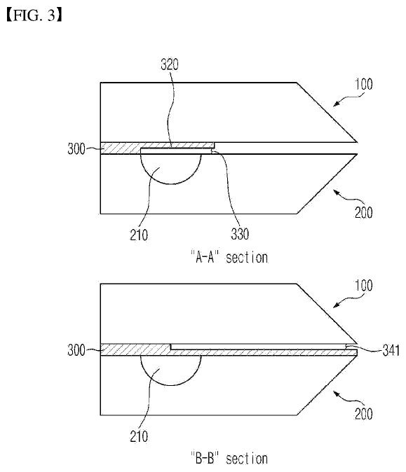

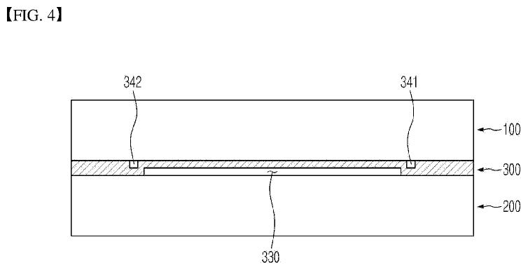

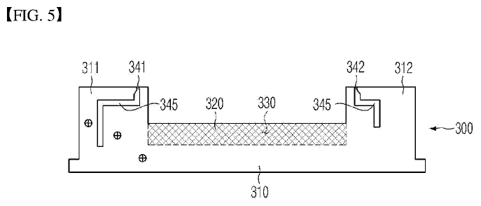

A specific configuration of the die coater shim 300 of the present embodiment will be described in detail with reference to FIGS. 3 to 5. FIG. 3 shows cross-sectional views taken along lines “A-A” and “B-B” of FIG. 2 in a state in which the die coater 10 of FIG. 2 is assembled, FIG. 4 is a front view of the die coater 10 of FIG. 2 in the state in which the die coater 10 is assembled, and FIG. 5 is a plan view illustrating a specific structure of the die coater shim 300 illustrated in FIG. 2.

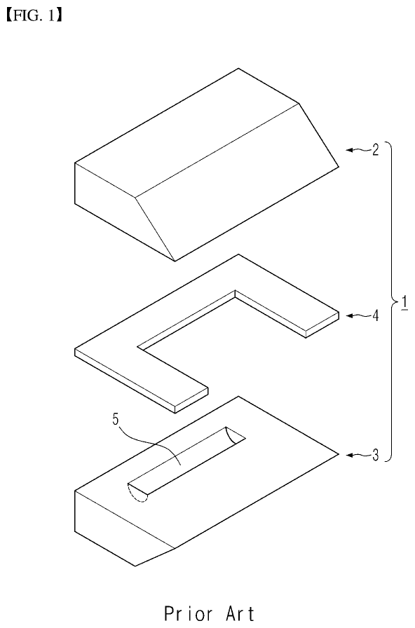

First, referring to FIG. 5, the die coater shim 300 includes a base 310 configured to extend in the width direction and the first and second guides 311 and 312 configured to protrude and extend from both ends of the base 310, and such a structure corresponds to the related art shown in FIG. 1.

Here, the die coater shim 300 of the present embodiment includes a step portion 320 configured to extend from the base 310 in the width direction between the first and second guides 311 and 312. A thickness of the step portion 320 is smaller than a thickness of the base 310, and accordingly, the step portion 320 forms a stepped space relative to one surface of the base 310 (a surface thereof facing the lower block). As shown in the “A-A” section of FIG. 3 and the front view of FIG. 4, the space that the step portion 320 forms communicates with the lower block 200 in which the manifold 210 is formed. Thus, the step portion 320 forms an electrode slurry slit 330 that forms a discharge path for the electrode slurry accommodated in the manifold 210.

Also, the first and second guides 311 and 312 each include a groove 345 formed in a surface corresponding to the other surface of the base 310 (a surface thereof facing the upper block), and as one end of each groove 345 forms an insulating coating liquid discharge path, first and second insulating coating liquid slits 341 and 342 are provided on the first and second guides 311 and 312. Referring to the “B-B” section of FIG. 3 and the front view of FIG. 4, the first and second insulating coating liquid slits 341 and 342 are formed toward the upper block 100, and accordingly, the electrode slurry slit 330 and the first and second insulating coating liquid slits 341 and 342 are physically separated from each other.

That is, upper and lower surfaces of the first and second guides 311 and 312 around the first and second insulating coating liquid slits 341 and 342 are in close contact with the upper block 100 and the lower block 200, and thus, along with the upper block 100, the first and second insulating coating liquid slits 341 and 342 form independent insulating coating liquid discharge paths isolated from surroundings thereof.

Also, the electrode slurry slit 330 is formed by the space that the step portion 320 between the first and second guides 311 and 312 forms, and accordingly, the electrode slurry discharge path is separated from the first and second guides 311 and 312 due to the step portion 320 and the lower block 200.

Therefore, since, inside the die coater 10, the first and second insulating coating liquid slits 341 and 342 are disposed toward the upper block 100, and the electrode slurry discharge path is disposed toward the lower block 200 and spatially separated, even when any one solution (the electrode slurry and/or the insulating coating liquid) leaks inside the die coater 10, mixing of the two solutions hardly occurs.

In an embodiment of the present invention, the step portion 320 may extend to a partial area in the width direction between the first and second guides 311 and 312. It is necessary for the step portion 320 to have a certain length because the step portion 320 serves to effectively separate the first and second guides 311 and 312 from the manifold 210 of the lower block 200. However, the length of the step portion 320 being too long may adversely affect a flow profile in the electrode slurry discharge path. For example, air bubbles may be present due to a vortex when the electrode slurry is discharged. Thus, there is a need to appropriately design the length of the step portion 320.

In a specific embodiment, a boundary between the base 310 and the step portion 320 may coincide with a rear end (a left side end in the “A-A” section of FIG. 3) of the manifold 210 provided in the lower block 200 to ensure tight sealing of the manifold 210, and an extending end portion of the step portion 320 may at least coincide with a front end of the manifold 210 or protrude from the front end of the manifold 210. For example, the extending end portion of the step portion 320 may protrude 10 mm or less from the front end of the manifold 210.

Also, the one end of the groove 345 that forms an outlet of the first and second insulating coating liquid slits 341 and 342 may extend to protruding end portions of the first and second guides 311 and 312. Such a configuration is shown in the “B-B” section of FIG. 3. Accordingly, the outlet of the first and second insulating coating liquid slits 341 and 342 is positioned at a sharp end portion of the die coater 10.

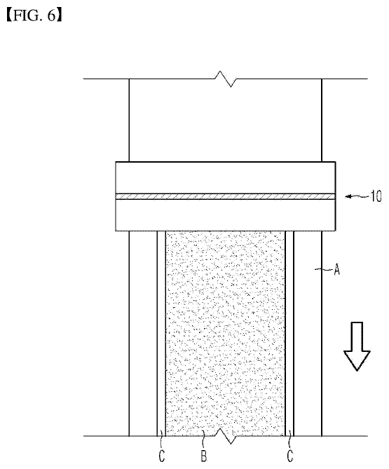

Also, in a specific embodiment, the one end of the groove 345 may be spaced apart from inner corners of the first and second guides 311 and 312 that face each other. A distance at which the one end of the groove 345 that forms the outlet of the first and second insulating coating liquid slits 341 and 342 is spaced apart from the inner corners of the first and second guides 311 and 312 corresponds to a distance at which the one end is spaced apart from both ends of an electrode slurry discharge width defined by the inner corners of the first and second guides 311 and 312. This is to, when an electrode slurry and an insulating coating liquid are simultaneously discharged, prevent the insulating coating liquid, which has slight fluidity, from being immediately mixed with a corner of the discharged electrode slurry. In this way, the edge of the electrode slurry is effectively protected by the insulating coating liquid. Simultaneously applying an electrode slurry B and an insulating coating liquid C on a current collector A using the die coater 10 of the present invention is shown in FIG. 6.

### Second Embodiment

A second embodiment of the present invention is an embodiment suitable for a case in which an electrode slurry and an insulating coating liquid are applied in two or more rows on a current collector supplied in the form of a coil and then slitting is performed.

That is, the second embodiment corresponds to an embodiment suitable for simultaneously applying an active material coating, which is formed of an “insulating coating liquid-electrode slurry-insulating coating liquid” structure, in two or more rows on a current collector.

In the second embodiment, there is no significant change in the configuration of the upper block 100 and the lower block 200 constituting the die coater 10, and a main difference is in the die coater shim 300. However, since additional insulating coating liquid slits 343 and 344 are present in the die coater shim 300 of the second embodiment, an additional insulating coating liquid inlet 110 corresponding thereto may be required in the upper block 100.

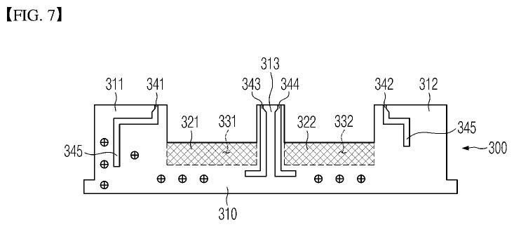

The configuration of the die coater shim 300 according to the second embodiment is shown in FIG. 7, and the second embodiment will be described focusing on the differences from the first embodiment described above.

Referring to FIG. 7, the die coater shim 300 of the second embodiment further includes a third guide 313 positioned between the first and second guides 311 and 312 and configured to protrude and extend from an intermediate portion of the base 310.

Also, as the third guide 313 is provided on the intermediate portion of the base 310, the step portion 320 is separated into a first step portion 321 disposed between the first guide and the third guide 313 and a second step portion 322 disposed between the third and second guides. Also, corresponding thereto, the electrode slurry slit 330 is divided into a first electrode slurry slit 331 configured to form one electrode slurry discharge path using the first step portion 321 and a second electrode slurry slit 332 configured to form another electrode slurry discharge path using the second step portion 322.

Also, a pair of grooves 345 are formed on a surface of the third guide 313 that corresponds to the other surface of the base 310 (the surface thereof facing the upper block), and one ends of the pair of grooves 345 constitute third and fourth insulating coating liquid slits 343 and 344 that form additional insulating coating liquid discharge paths.

Referring to FIG. 7 with reference to the first embodiment, a structure that the first and third guides 311 and 313 constitute and a structure that the third and second guides 313 and 312 constitute are symmetrical to each other. That is, the die coater shim 300 of the second embodiment may be described as a structure in which two die coater shims 300 of the first embodiment are coupled in parallel in a transfer direction of the current collector A (see FIG. 6).

Therefore, using the die coater shim 300 of FIG. 7, an active material may be simultaneously applied in two rows on a current collector in order to be suitable for slitting. In a case in which widths of two rows of electrode slurries are equal to each other, widths of the first and second step portions 321 and 322 may be made equal to each other. Here, since the width of the insulating coating liquid is almost constant regardless of the width of the electrode slurry, there is no need to significantly change the configuration of the third and fourth insulating coating liquid slits 343 and 344.

The present invention has been described in detail above using the drawings, embodiments, or the like. However, configurations illustrated or described in the drawings or embodiments herein are only some embodiments of the present invention and do not represent the entire technical spirit of the present invention. Therefore, it should be understood that various equivalents and modifications that may replace the corresponding configurations may be present at the time of filing this application.

### DESCRIPTION OF REFERENCE NUMERALS

10: die coater
100: upper block
110: insulating coating liquid inlet
200: lower block
210: manifold
300: die coater shim
310: base
311; first guide
312: second guide
313: third guide
320: step portion
321: first step portion
322: second step portion
330: electrode slurry slit
331: first electrode slurry slit
332: second electrode slurry slit
341: first insulating coating liquid slit
342: second insulating coating liquid slit
343: third insulating coating liquid slit
344: fourth insulating coating liquid slit
345: groove

### INDUSTRIAL APPLICABILITY

The present invention is suitable for application to a die coater for simultaneously coating an electrode slurry and an insulating coating liquid on a current collector for a secondary battery.

1. A die coater shim for simultaneously applying an electrode slurry and an insulating coating liquid on a current collector, the die coater shim comprising:
a base configured to extend in a width direction;
first and second guides disposed on each end of the base in the width direction, wherein the first and second guides protrude and extend from the base in a direction orthogonal to the width direction;
a first electrode slurry slit including a first step portion disposed between the first and second guides in the width direction, wherein a thickness of the first step portion is smaller than a thickness of the base, wherein the thickness of the first step portion forms a first stepped space relative to a first surface of the base, wherein the first stepped space forms an electrode slurry discharge path; and
first and second insulating coating liquid slits including a groove formed on a surface of each of the first and second guides disposed on a second surface of the base, wherein one end of each of the grooves forms an insulating coating liquid discharge path.

2. The die coater shim of claim 1, wherein the step portion extends to a partial area in the width direction between the first and second guides, wherein the first and second guides protrude and extend from the partial area in the direction orthogonal to the width direction.

3. The die coater shim of claim 1, wherein the one end of each of the grooves forms an outlet of the first and second insulating coating liquid slits, wherein the one end of each of the grooves extends to a protruding end portion of each of the first and second guides.

4. The die coater shim of claim 3, wherein the one end of each of the grooves is spaced further apart in the width direction from inner corners of the first and second guides.

5. The die coater shim of claim 1, further comprising:
a third guide positioned between the first and second guides, wherein the third guide protrudes and extends from the base in the direction orthogonal to the width direction; and
third and fourth insulating coating liquid slits including a pair of grooves formed on a surface of the third guide, wherein one end of each of the pair of grooves forms an insulating coating liquid discharge path,
wherein the step portion includes a first step portion and a second step portion, wherein the first step portion is disposed between the first and third guides and the second step portion is disposed between the third and second guides,
wherein the electrode slurry slit includes the first electrode slurry slit and a second electrode slurry slit, wherein the second electrode slurry slit includes a second step portion, wherein a second thickness of the second step portion is smaller than the thickness of the base, wherein the thickness the second step portion forms a second stepped space relative to the first surface of the base, wherein the second stepped space forms a second electrode slurry discharge path.

6. The die coater shim of claim 5, wherein an outlet of the third insulating coating liquid slit faces the first guide and an outlet of the fourth insulating coating liquid faces the second guide.

7. The die coater shim of claim 5, wherein a width of each of the first and second step portions are equal.

8. A die coater comprising:
an upper block having an insulating coating liquid inlet;
a lower block coupled to the upper block, wherein the lower block includes a manifold configured to accommodate an electrode slurry; and
a die coater shim interposed between the upper block and the lower block so as to form a slit, wherein the die coater is configured to simultaneously discharge an insulating coating liquid and the electrode slurry through the slit,
wherein the die coater shim has an electrode slurry discharge path formed on a first surface of the base and an insulating coating liquid discharge path formed on a second surface of the base,
wherein the electrode slurry discharge path and the insulating coating liquid discharge path are physically separated from each other on the die coater shim.

9. The die coater of claim 8, wherein the die coater shim includes:
a base configured to extend in a width direction;
first and second guides disposed on each end of the base in the width direction, wherein the first and second guides protrude and extend from the base in a direction orthogonal to the width direction;
an electrode slurry slit including a step portion disposed between the first and second guides in the width direction, wherein a thickness of the step portion is smaller than a thickness of the base, wherein the thickness of the step portions forms a stepped space relative to a first surface of the base, wherein the stepped space forms the electrode slurry discharge path; and
first and second insulating coating liquid slits including a groove formed on a surface of each of the first and second guides disposed on a second surface of the base, wherein one end of each of the grooves form the insulating coating liquid discharge path.

10. The die coater of claim 9, wherein the step portion extends to a partial area in the width direction between the first and second guides, wherein the first and second guides protrude and extend from the partial area in the direction orthogonal to the width direction.

11. The die coater of claim 10, wherein:
a boundary between the base and the step portion coincides with a rear end of the manifold provided in the lower block, wherein the rear end of the manifold is disposed adjacent to the base of the die coater; and
an end portion of the step portion coincides with a front end of the manifold or protrudes from the front end of the manifold, wherein the front end of the manifold is disposed further away from the base of the die coater than the rear end of the manifold.

12. The die coater of claim 11, wherein the end portion of the step portion protrudes 10 mm or less from the front end of the manifold.

13. The die coater of claim 9, wherein the one end of each of the grooves forms an outlet of the first and second insulating coating liquid slits, wherein the one end of each of the grooves extends to a protruding end portion of each of the first and second guides.

14. The die coater of claim 13, wherein the one end of each of the grooves is spaced further apart in the width direction from inner corners of the first and second guides.
